(19) United States
(12) Patent Application Publication
(10) Pub. No.: US 2008/0112573 A1
(43) Pub. Date: May 15, 2008

(54) Wireless Signal Transmitting and Receiving System with Adjustable Signal Transmission Directionality

(76) Inventor: David Huang, Kaohsiung City (TW)

Correspondence Address: MCNEES WALLACE & NURICK LLC, 100 PINE STREET, P.O. BOX 1166, HARRISBURG, PA, 17108-1166, US

(21) Appl. No.: 11/558,641

(22) Filed: Nov. 10, 2006

(51) Int. Cl. H04B 7/00; H04B 1/00; H04R 25/00

(52) U.S. Cl. 381/86; 381/370; 455/41.2

(57) ABSTRACT

A signal transmitting and receiving system is adapted for use in a vehicle cabin, and includes a transmitting device and a receiving device. The transmitting device includes a first processing unit for receiving signals from a signal source, a directional transmitting unit coupled to the first processing unit and operable so as to wirelessly transmit signals from the first processing unit along a primary signal transmitting direction, and a driving unit for coupling rotatably the directional transmitting unit to the first processing unit such that the primary signal transmitting direction is adjustable relative to the first processing unit. The receiving device includes a receiving unit for receiving the signals wirelessly transmitted by the directional transmitting unit, and a second processing unit coupled to the receiving unit for processing signals received therefrom.

### BACKGROUND OF THE INVENTION

1. Field of the Invention

The invention relates to a signal transmitting and receiving system, more particularly to a wireless signal transmitting and receiving system adapted for use in a cabin of a vehicle.

2. Description of the Related Art

Passenger vehicles, such as airplanes, are provided with wired headphone systems that enable passengers to listen to music or television programs by plugging signal terminals of passenger headsets into dedicated sockets on armrests of passenger seats.

To make a trip more comfortable, passengers are usually provided with pillows, blankets, and the like. Travel regulations also require passengers to buckle up their safety belts. With so many objects around, wires of the headsets can interfere with posture of passengers especially during meals in view of the limited space of passenger seats. There is thus a need for wireless headphone systems suitable for use in a cabin of a vehicle.

However, for traffic safety, the Federal Aviation Administration (FAA) imposes stringent restrictions on the amount of electromagnetic interference (EMI) radiated in a passenger cabin of an airplane. For this reason, conventional wireless headphone devices available for household use are unsuited for use in airplanes.

### SUMMARY OF THE INVENTION

Therefore, the object of the present invention is to provide a signal transmitting and receiving system that is suitable for use in a cabin of an airplane.

According to one aspect of the present invention, there is provided a signal transmitting and receiving system that comprises a transmitting device and a receiving device. The transmitting device includes a first processing unit adapted for receiving signals from a signal source, a directional transmitting unit coupled to the first processing unit and operable so as to wirelessly transmit signals from the first processing unit along a primary signal transmitting direction, and a driving unit for coupling rotatably the directional transmitting unit to the first processing unit such that the primary signal transmitting direction is adjustable relative to the first processing unit. The receiving device includes a receiving unit for receiving the signals wirelessly transmitted by the directional transmitting unit, and a second processing unit coupled to the receiving unit for processing signals received therefrom.

According to another aspect of the present invention, there is provided a signal transmitting device that comprises a processing unit adapted for receiving signals from a signal source, a directional transmitting unit coupled to the processing unit and operable so as to wirelessly transmit signals from the processing unit along a primary signal transmitting direction, and a driving unit for coupling rotatably the directional transmitting unit to the processing unit such that the primary signal transmitting direction is adjustable relative to the processing unit.

According to yet another aspect of the present invention, there is provided a signal receiving device that comprises: a receiving unit including an infrared light receiver that is adapted for receiving wirelessly transmitted signals; a processing unit coupled to the receiving unit for processing signals received therefrom; a speaker unit connected to the processing unit for receiving and reproducing the signals processed by the processing unit; and a headphone housing that has the receiving unit, the processing unit and the speaker unit mounted therein, the headphone housing having a bottom part provided with an infrared light filter that is disposed to correspond in position with the infrared light receiver.

### BRIEF DESCRIPTION OF THE DRAWINGS

Other features and advantages of the present invention will become apparent in the following detailed description of the preferred embodiment with reference to the accompanying drawings, of which:

FIG. 1 illustrates the preferred embodiment of a signal transmitting and receiving system according to the present invention applied to a cabin of a vehicle;

FIG. 2 is a block diagram of a transmitting device of the preferred embodiment;

FIG. 3 is a perspective view showing a driving unit of the transmitting device of the preferred embodiment;

FIG. 4 is a schematic view showing a conductor unit of the driving unit of the transmitting device of the preferred embodiment;

FIG. 5 is a block diagram of a receiving device of the preferred embodiment;

FIG. 6 is a partly cutaway perspective view to show a directional transmitting unit of the transmitting device of the preferred embodiment;

FIG. 7 is a radiation pattern of the directional transmitting unit of the preferred embodiment;

FIG. 8 is a block diagram of a first processing unit of the transmitting device of the preferred embodiment;

FIG. 9 is a block diagram of a second processing unit of the receiving device of the preferred embodiment; and

FIG. 10 is a perspective view of the signal transmitting and receiving system of the preferred embodiment.

### DETAILED DESCRIPTION OF THE PREFERRED EMBODIMENT

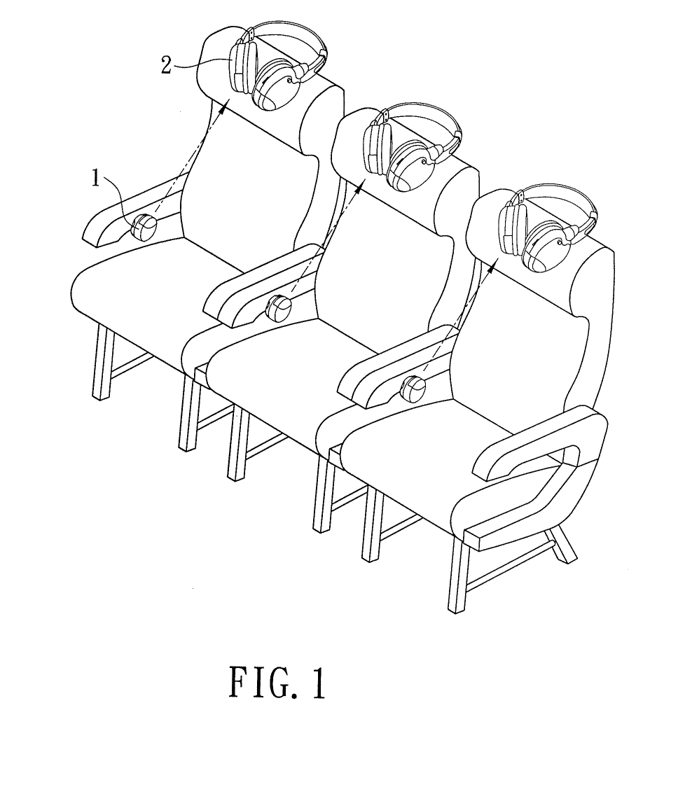

Referring to FIG. 1, the preferred embodiment of a signal transmitting and receiving system according to the present invention is shown to be adapted for use in a cabin of a vehicle, such as an airplane. The signal transmitting and receiving system comprises a transmitting device 1 and a receiving device 2.

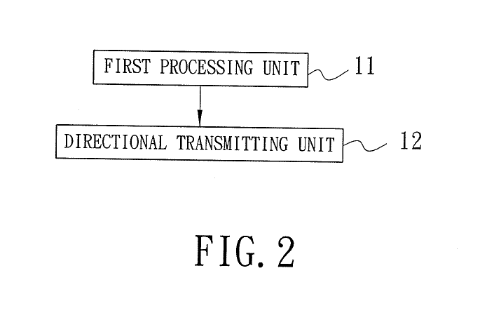

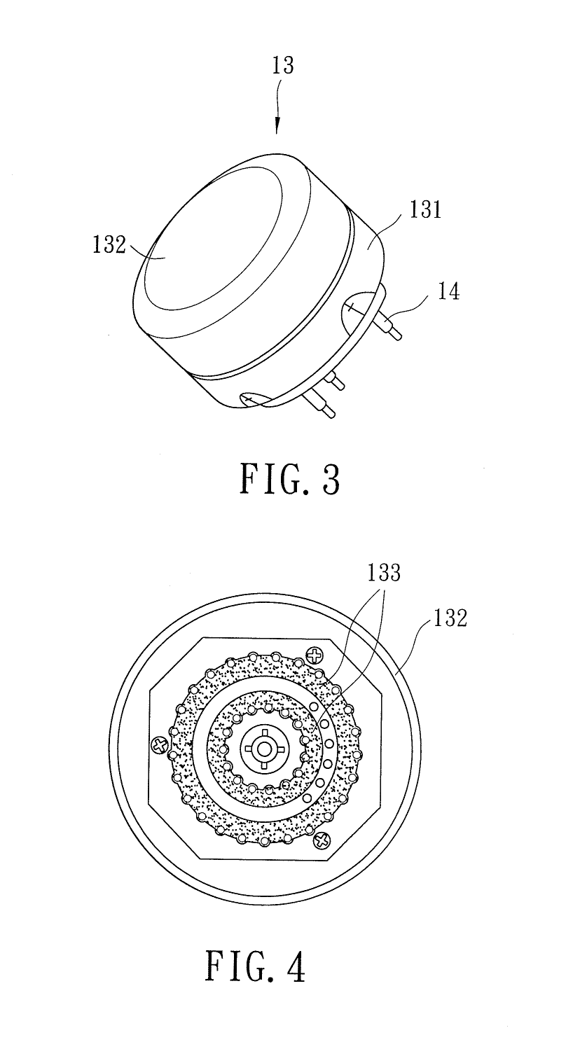

Referring to FIGS. 2 to 4, the transmitting device 1 includes a first processing unit 11, a directional transmitting unit 12, a driving unit 13, and a signal terminal 14.

The driving unit 13 includes a fixing disc 131, a rotary disc 132, and a conductor unit 133. The fixing disc 131 has the first processing unit 11 mounted thereon. The rotary disc 132 has the directional transmitting unit 12 mounted thereon. The rotary disc 132 is coupled rotatably to the fixing disc 131 such that the rotary disc 132 and the directional transmitting unit 12 are co-rotatable relative to the first processing unit 11. The conductor unit 133 is coupled between the fixing disc 131 and the rotary disc 132. In particular, the first processing unit 11 makes electrical connection with one surface of the conductor unit 133 that faces the fixing disc 131, while the directional transmitting unit 12 makes electrical connection with the other surface of the conductor unit 133 that faces the rotary disc 132. As a result, electrical connection between the directional transmitting unit 12 and the first processing unit 11 is established via the conductor unit 133 and can be maintained even when the rotary disc 132 is rotated relative to the fixing disc 131.

The signal terminal 14 is coupled to the first processing unit 11 and extends out of the fixing disc 131 so as to be adapted for plugging into a dedicated socket on an armrest of a passenger seat in the vehicle cabin for establishing electrical connection between the first processing unit 11 and a signal source, e.g., an audio signal source.

The first processing unit 11 processes signals received from the signal source, and provides processed signals to the directional transmitting unit 12, which is responsible for wirelessly transmitting the same.

It should be noted herein that the directional transmitting unit 12 does not transmit signals omni-directionally, but is operable so as to wirelessly transmit signals from the first processing unit 11 along a primary signal transmitting direction. The directional transmitting unit 12 thus includes a directional or slanting directional radiating component (to be described in greater detail in the succeeding paragraphs).

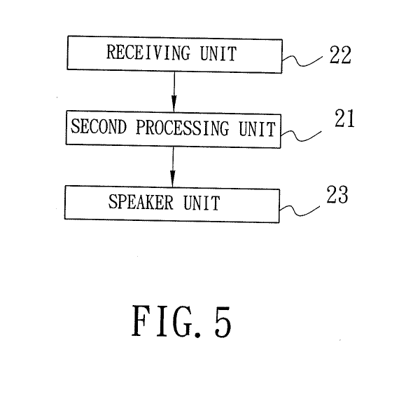

Referring to FIGS. 1, 5 and 10, the receiving device 2 includes a second processing unit 21, a receiving unit 22, a speaker unit 23, and a headphone housing 24 that has the second processing unit 21, the receiving unit 22 and the speaker unit 23 mounted therein, and that is adapted for use by a passenger seated in the vehicle cabin.

The receiving unit 22 receives signals wirelessly transmitted by the directional transmitting unit 12 of the transmitting device 1.

The second processing unit 21 is coupled to the receiving unit 22 for processing signals received therefrom.

The speaker unit 23 is connected to the second processing unit 21 for receiving and reproducing the signals processed by the second processing unit 21.

In view of the directional characteristics of signals transmitted by the directional transmitting unit 12, interference with signals transmitted by the transmitting device 1 on an adjacent passenger seat can be avoided. Moreover, by virtue of the driving unit 13, the primary signal transmitting direction of the directional transmitting unit 12 is adjustable by the passenger to ensure optimum signal reception by the receiving device 2.

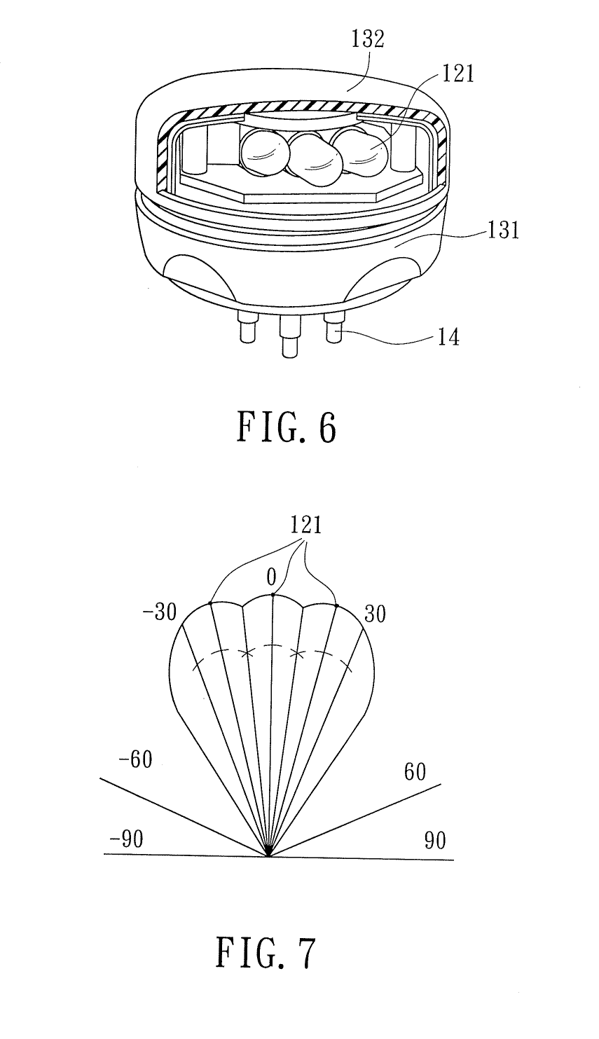

In this embodiment, the directional transmitting unit 12 includes three infrared light emitters 121 (as best shown in FIG. 6), whereas the receiving unit 22 includes an infrared light receiver.

Each of the infrared light emitters 121 transmits infrared light with a limited beam width (e.g., 60 degrees) along a primary transmitting direction. In this embodiment, each of the infrared light emitters 121 transmits light with a wavelength of 850 nm. The three infrared light emitters 121 are connected in series and are so disposed such that the primary transmitting directions of adjacent ones of the infrared light emitters 121 are spaced apart by an angle of approximately 20 degrees, such that the radiation patterns of each adjacent pair of the infrared light emitters 121 overlap, and such that the infrared light emitters 121 cooperatively impart the directional transmitting unit 12 with a collective radiation pattern having a ±30° half-power beam width, as best shown in FIG. 7.

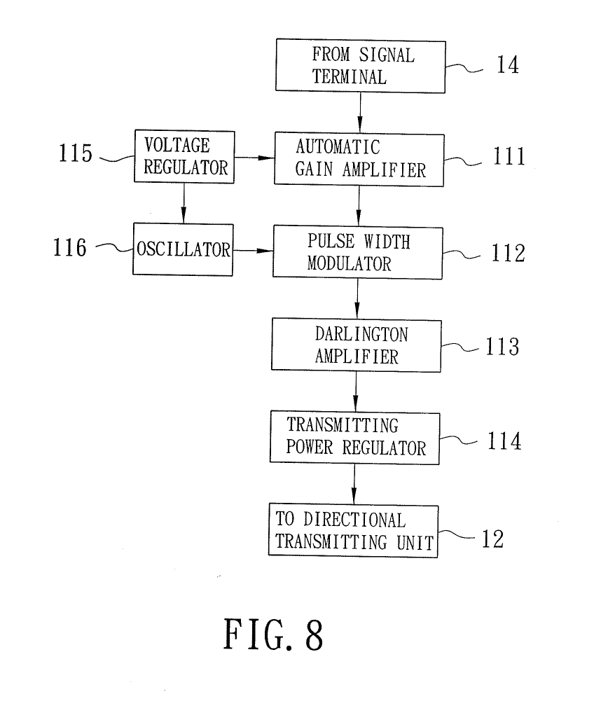

Referring to FIG. 8, the first processing unit 11 includes an automatic gain amplifier 111 adapted to be connected to the signal source through the signal terminal 14 for amplitude adjustment of the signals received from the signal source, a pulse width modulator 112 connected to the automatic gain amplifier 111 for modulating signals received therefrom, an oscillator 116 connected to the pulse width modulator 112 for providing a frequency output thereto, a Darlington amplifier 113 connected to the pulse width modulator 112 for amplitude modulation of current component of signals received therefrom, a transmitting power regulator 114 connected to the Darlington amplifier 113 for power regulation of signals to be provided to and transmitted by the directional transmitting unit 12, and a voltage regulator 115 connected to the automatic gain amplifier 111 and the oscillator 116 so as to stabilize voltage of the automatic gain amplifier 111 and the frequency output of the oscillator 116. The automatic gain amplifier 111 serves to minimize distortion of modulated signals from the pulse width modulator 112. By virtue of the transmitting power regulator 114, an effective transmission range of not more than two meters is possible for the directional transmitting unit 12.

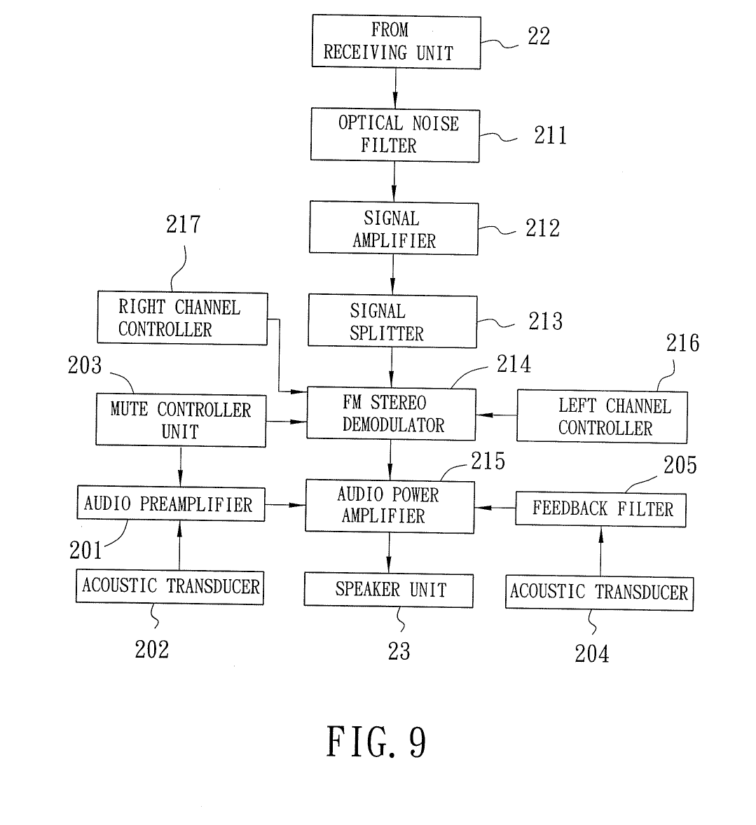

Referring to FIG. 9, the second processing unit 21 of this embodiment includes an optical noise filter 211 for filtering out noise signals, the wavelength of which is shorter than that of infrared light (for instance, interference attributed to sunspots), from the signals received by the receiving unit 22, a signal amplifier 212 (which is a radio frequency signal amplifier in this embodiment) connected to the optical noise filter 211 for demodulating infrared amplitude-modulated signals therefrom to result in frequency-modulated signals, a signal splitter 213 connected to the signal amplifier 212 for splitting the frequency-modulated signals into left and right FM waves, a FM stereo demodulator 214 connected to the signal splitter 213 for demodulating the left and right FM waves to result in left and right channel signals, and an audio power amplifier 215 interconnecting the FM stereo demodulator 214 and the speaker unit 23 for amplifying the left and right channel signals that are subsequently provided to the speaker unit 23. The second processing unit 21 further includes left and right channel controllers 216, 217 coupled to the FM stereo demodulator 214. Each of the left and right channel controllers 216, 217 is operable to control characteristics, such as sound volume, of a respective one of the left and right channel signals.

To ensure that a passenger using the system of this invention is able to hear announcements made by flight personnel, the second processing unit 21 of this embodiment is shown to further include an acoustic transducer 202 for sound pickup (for instance, announcements made by flight personnel), an audio preamplifier 201 connected to the acoustic transducer 202 and the audio power amplifier 215 and operable so as to amplify sounds picked up by the acoustic transducer 202, and a mute controller unit 203 that is connected to the audio preamplifier 201 and the FM stereo demodulator 214, and that is selectively operable via a switch so as to suppress output of the left and right channel signals by the FM stereo demodulator 214 and so as to simultaneously enable output of amplified sounds from the audio preamplifier 201 to the audio power amplifier 215, thereby enabling broadcast of announcements made by flight personnel.

Moreover, in the prior art, listeners usually turn up the volume to drown out background noise, which may cause ear injury. In order to avoid the need for listeners to turn up the volume for the sake of drowning out background noise, the second processing unit 21 further includes another acoustic transducer 204 for pickup of background sound and disposed together with the speaker unit 23 in a sealed compartment, and a feedback filter 205 connected to the acoustic transducer 204 and the audio power amplifier 215 and operable to filter out a noise component from output of the acoustic transducer 204 and to generate a noise compensating signal that corresponds to the noise component (i.e., having a same magnitude but opposite polarity as the noise component) and that is provided to the audio power amplifier 215 to counteract effect of background noise.

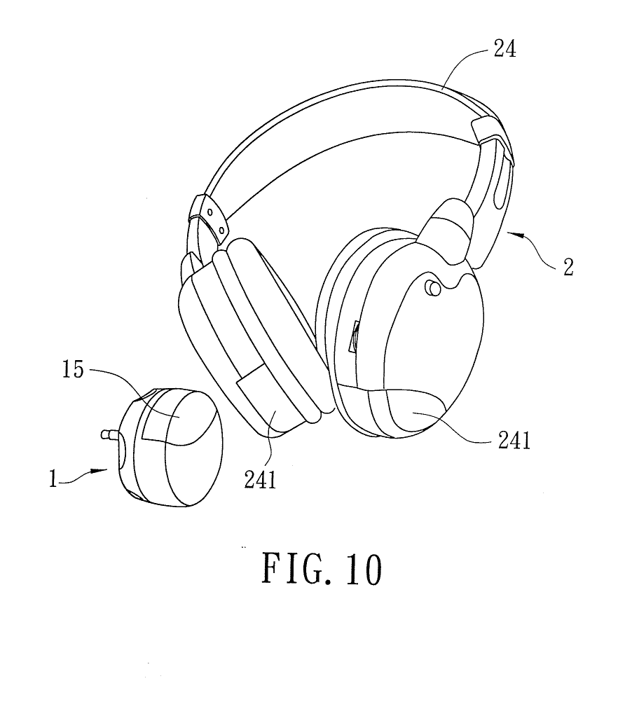

Referring to FIG. 10, the headphone housing 24 has a bottom part provided with an infrared light filter 241 that is disposed to correspond in position with the infrared light receiver of the receiving unit 22 such that only infrared light transmitted by the correct transmitting device 1 can be received by the receiving unit 22 and such that infrared light from other directions can be blocked. Examples of infrared light from other directions include those transmitted by adjacent transmitting devices 1 and reflected by a roof of the vehicle cabin. The transmitting device 1 is likewise provided with an infrared light filter 15 disposed at a position corresponding to the infrared light emitters 121 (see FIG. 6) for improving transmission efficiency.

Since infrared light transmission is employed in the system of this embodiment, the system can comply with the EMI restrictions imposed by the FAA.

However, it should be noted herein that the mode of transmission suitable for the present invention should not be limited to infrared light transmission. The passenger seats of most airplanes are currently installed with display devices that also generate a certain amount of electromagnetic interference. Since the presence of these display devices posed no safety concerns, there is a possibility that the FAA may relax its EMI restrictions in the future.

Therefore, instead of infrared light transmission, the mode of transmission between the transmitting and receiving devices of the system of this invention may be based on a Bluetooth protocol in other embodiments of this invention. Compared to commercially available Bluetooth devices, the transmitting power is considerably reduced in the system of this invention to comply with future FAA restrictions.

Moreover, a conventional Bluetooth device uses an omni-directional antenna for signal transmission in all directions with a transmission range of at least 10 meters. In contrast, the directional transmitting unit of the transmitting device of the system of this invention, which is based on a Bluetooth protocol, uses a directional or slanting directional antenna for signal transmission along a primary signal transmitting direction so as to minimize undesired electromagnetic interference. In addition, the transmitting power is reduced to result in a transmission range that is not more than two meters, which is sufficient for a passenger seated in a vehicle cabin. Furthermore, by virtue of the driving unit of the transmitting device, the primary signal transmitting direction of the directional transmitting unit is adjustable by the passenger to ensure optimum signal reception by the receiving device.

The first and second processing units of the system of this invention, which is based on a Bluetooth protocol, can be realized using conventional CSR BlueCore 3 chip sets. Since the feature of this invention does not reside in the implementation of the first and second processing units in the Bluetooth-based system, further details of the same are omitted herein for the sake of brevity.

The mode of transmission between the transmitting and receiving devices of the system of this invention may be based on other wireless radio-frequency communications schemes, such as 802.11a/b/g, in further embodiments of this invention. Compared to commercially available wireless radio-frequency devices, the transmitting power is considerably reduced in the system of this invention to comply with safety restrictions.

Moreover, a conventional 802.11a/b/g device uses an omni-directional antenna for signal transmission in all directions with a transmission range of over 100 meters. In contrast, the directional transmitting unit of the transmitting device of the system of this invention, which is based on 802.11a/b/g, uses a directional or slanting directional antenna for signal transmission along a primary signal transmitting direction so as to minimize undesired electromagnetic interference. In addition, the transmitting power is reduced to result in a transmission range that is not more than two meters, which is sufficient for a passenger seated in a vehicle cabin. Furthermore, by virtue of the driving unit of the transmitting device, the primary signal transmitting direction of the directional transmitting unit is adjustable by the passenger to ensure optimum signal reception by the receiving device.

The first and second processing units of the system of this invention, which is based on 802.11a/b/g, can be realized using conventional NRF 24Z1 (wireless audio streamer) chip sets. Since the feature of this invention does not reside in the implementation of the first and second processing units in the 802.11a/b/g-based system, further details of the same are omitted herein for the sake of brevity.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A signal transmitting and receiving system adapted for use in a cabin of a vehicle, said signal transmitting and receiving system comprising:
a transmitting device including
a first processing unit adapted for receiving signals from a signal source,
a directional transmitting unit coupled to said first processing unit and operable so as to wirelessly transmit signals from said first processing unit along a primary signal transmitting direction, and
a driving unit for coupling rotatably said directional transmitting unit to said first processing unit such that the primary signal transmitting direction is adjustable relative to said first processing unit; and
a receiving device including
a receiving unit for receiving the signals wirelessly transmitted by said directional transmitting unit, and
a second processing unit coupled to said receiving unit for processing signals received therefrom.

2. The signal transmitting and receiving system as claimed in claim 1, wherein said driving unit includes a rotary disc having said directional transmitting unit mounted thereon, said rotary disc and said directional transmitting unit being co-rotatable relative to said first processing unit.

3. The signal transmitting and receiving system as claimed in claim 2, wherein said driving unit further includes a fixing disc having said first processing unit mounted thereon, said rotary disc being coupled rotatably to said fixing disc.

4. The signal transmitting and receiving system as claimed in claim 3, wherein said driving unit further includes a conductor unit coupled between said fixing disc and said rotary disc to establish electrical connection between said directional transmitting unit and said first processing unit.

5. The signal transmitting and receiving system as claimed in claim 1, wherein said transmitting device further includes a signal terminal adapted for establishing electrical connection between said first processing unit and the signal source.

6. The signal transmitting and receiving system as claimed in claim 1, wherein said receiving device further includes:
a headphone housing for mounting said receiving unit and said second processing unit therein; and
a speaker unit mounted in said headphone housing and connected to said second processing unit for receiving and reproducing the signals processed by said second processing unit.

7. The signal transmitting and receiving system as claimed in claim 6, wherein said directional transmitting unit includes an infrared light emitter, said transmitting device further including an infrared light filter disposed at a position corresponding to said infrared light emitter, said receiving unit including an infrared light receiver, said headphone housing having a bottom part provided with an infrared light filter that is disposed to correspond in position with said infrared light receiver.

8. The signal transmitting and receiving system as claimed in claim 1, wherein said directional transmitting unit includes an infrared light emitter, and said receiving unit includes an infrared light receiver.

9. The signal transmitting and receiving system as claimed in claim 8, wherein said first processing unit includes:
an automatic gain amplifier adapted to be connected to the signal source for amplitude adjustment of the signals received therefrom;
a pulse width modulator connected to said automatic gain amplifier for modulating signals received therefrom;
a Darlington amplifier connected to said pulse width modulator for amplitude modulation of signals received therefrom; and
a transmitting power regulator connected to said Darlington amplifier for power regulation of signals to be provided to and transmitted by said directional transmitting unit.

10. The signal transmitting and receiving system as claimed in claim 8, wherein said second processing unit includes:
an optical noise filter for filtering out noise signals, the wavelength of which is shorter than that of infrared light;
a signal amplifier connected to said optical noise filter for demodulating infrared amplitude-modulated signals therefrom to result in frequency-modulated signals;
a signal splitter connected to said signal amplifier for splitting the frequency-modulated signals into left and right FM waves;
a FM stereo demodulator connected to said signal splitter for demodulating the left and right FM waves to result in left and right channel signals; and
an audio power amplifier connected to said FM stereo demodulator for amplifying the left and right channel signals.

11. The signal transmitting and receiving system as claimed in claim 10, wherein said second processing unit further includes:
an acoustic transducer for sound pickup;
an audio preamplifier connected to said acoustic transducer and said audio power amplifier, and operable so as to amplify sounds picked up by said acoustic transducer; and
a mute controller unit connected to said audio preamplifier and said FM stereo demodulator, and selectively operable so as to suppress output of the left and right channel signals by said FM stereo demodulator and so as to simultaneously enable output of amplified sounds from said audio preamplifier to said audio power amplifier.

12. The signal transmitting and receiving system as claimed in claim 10, wherein said second processing unit further includes:
an acoustic transducer for sound pickup; and
a feedback filter connected to said acoustic transducer and said audio power amplifier, and operable to filter out a noise component from output of said acoustic transducer and to generate a noise compensating signal that corresponds to the noise component and that is provided to said audio power amplifier to counteract effect of background noise.

13. The signal transmitting and receiving system as claimed in claim 1, wherein said directional transmitting unit includes a directional antenna, and communicates with said receiving unit according to a Bluetooth protocol.

14. The signal transmitting and receiving system as claimed in claim 1, wherein said directional transmitting unit includes a directional antenna, and communicates with said receiving unit through wireless radio-frequency communications.

15. A signal transmitting device adapted for use in a cabin of a vehicle, comprising:
a processing unit adapted for receiving signals from a signal source;
a directional transmitting unit coupled to said processing unit and operable so as to wirelessly transmit signals from said processing unit along a primary signal transmitting direction; and
a driving unit for coupling rotatably said directional transmitting unit to said processing unit such that the primary signal transmitting direction is adjustable relative to said processing unit.

16. The signal transmitting device as claimed in claim 15, wherein said driving unit includes a rotary disc having said directional transmitting unit mounted thereon, said rotary disc and said directional transmitting unit being co-rotatable relative to said processing unit.

17. The signal transmitting device as claimed in claim 16, wherein said driving unit further includes a fixing disc having said processing unit mounted thereon, said rotary disc being coupled rotatably to said fixing disc.

18. The signal transmitting device as claimed in claim 17, wherein said driving unit further includes a conductor unit coupled between said fixing disc and said rotary disc to establish electrical connection between said directional transmitting unit and said processing unit.

19. The signal transmitting device as claimed in claim 15, further comprising a signal terminal adapted for establishing electrical connection between said processing unit and the signal source.

20. The signal transmitting device as claimed in claim 15, wherein said directional transmitting unit includes an infrared light emitter.

21. The signal transmitting device as claimed in claim 15, wherein said directional transmitting unit includes a directional antenna, and transmits signals according to a Bluetooth protocol.

22. The signal transmitting device as claimed in claim 15, wherein said directional transmitting unit includes a directional antenna, and transmits signals through wireless radio-frequency communications.

23. A signal receiving device adapted for use in a cabin of a vehicle, comprising:
a receiving unit including an infrared light receiver that is adapted for receiving wirelessly transmitted signals;
a processing unit coupled to said receiving unit for processing signals received therefrom;
a speaker unit connected to said processing unit for receiving and reproducing the signals processed by said processing unit; and
a headphone housing for mounting said receiving unit, said processing unit and said speaker unit therein, said headphone housing having a bottom part provided with an infrared light filter that is disposed to correspond in position with said infrared light receiver.

24. The signal receiving device as claimed in claim 23, wherein said processing unit includes:
an optical noise filter for filtering out noise signals, the wavelength of which is shorter than that of infrared light;
a signal amplifier connected to said optical noise filter for demodulating infrared amplitude-modulated signals therefrom to result in frequency-modulated signals;
a signal splitter connected to said signal amplifier for splitting the frequency-modulated signals into left and right FM waves;
a FM stereo demodulator connected to said signal splitter for demodulating the left and right FM waves to result in left and right channel signals; and
an audio power amplifier connected to said FM stereo demodulator for amplifying the left and right channel signals.

25. The signal receiving device as claimed in claim 24, wherein said processing unit further includes:
an acoustic transducer for sound pickup;
an audio preamplifier connected to said acoustic transducer and said audio power amplifier, and operable so as to amplify sounds picked up by said acoustic transducer; and
a mute controller unit connected to said audio preamplifier and said FM stereo demodulator, and selectively operable so as to suppress output of the left and right channel signals by said FM stereo demodulator and so as to simultaneously enable output of amplified sounds from said audio preamplifier to said audio power amplifier.

26. The signal receiving device as claimed in claim 24, wherein said processing unit further includes:
an acoustic transducer for sound pickup; and
a feedback filter connected to said acoustic transducer and said audio power amplifier, and operable to filter out a noise component from output of said acoustic transducer and to generate a noise compensating signal that corresponds to the noise component and that is provided to said audio power amplifier to counteract effect of background noise.
